(19) United States
(12) Patent Application Publication
(10) Pub. No.: US 2014/0267461 A1
(43) Pub. Date: Sep. 18, 2014

(54) LED-BASED LIGHT ENGINE

(71) Applicant: Permlight Products, Inc., Tustin, CA (US)

(72) Inventors: Kamran Sarmadi, Arcadia, CA (US); Ismael Lopez, Santa Ana, CA (US)

(73) Assignee: Permlight Products, Inc., Tustin, CA (US)

(21) Appl. No.: 14/216,951

(22) Filed: Mar. 17, 2014

Related U.S. Application Data
(60) Provisional application No. 61/788,791, filed on Mar. 15, 2013.

(51) Int. Cl. G09G 3/32

(52) U.S. Cl. CPC G09G 3/32
USPC 345/690; 345/83

(57) ABSTRACT

An LED-based light engine has a circuit board upon which at least one LED circuit is mounted. A power driver is also mounted on the circuit board. The power driver accepts an AC input power and outputs a DC output power that powers the LED circuit. The circuit board is divided into an LED zone and a driver zone, which are thermally insulated relative to one another so that heat does not flow between the LED and driver zones. Slots are formed through the circuit board between the LED zone and driver zone to further block heat flow between the LED and driver zones.

### CROSS-REFERENCE TO RELATED APPLICATIONS

The application claims the benefit of U.S. Provisional Application No. 61/788,791, which was filed Mar. 15, 2013, the entirety of which is hereby incorporated by reference.

### BACKGROUND

The present disclosure relates to the field of LED-based light engines.

Light emitting diodes have become increasingly popular for use in space lighting applications. Their compactness, efficiency, low toxicity, and long life are particularly attractive for providing environmentally friendly lighting.

LED-based light engines typically include a printed circuit board upon which the LEDs are mounted. A power driver having power conditioning circuitry also is necessary to receive an AC input power and condition the input power to a DC output and voltage appropriate for the LED circuit on the circuit board.

LEDs can be damaged if subjected to excessive heat. As such, prepackaged LEDs typically are manufactured with significant heat transfer structure that helps to evacuate heat from the LED. Similarly, power conditioning componentry in power drivers is also susceptible to heat damage. If the LEDs and power driver are mounted in close proximity to one another, excessive heat generated by one of these components may damage the other component.

### SUMMARY

There is a need in the art for a LED-based light engine in which the power driver and LEDs can be mounted in close proximity, such as on the same circuit board, but be thermally insulated from one another so that excessive heat generated by the LEDs will not impinge upon and damage componentry of the power driver, and vice versa.

In accordance with one embodiment, an LED-based light engine comprises a printed circuit board having a component side and a back side. A first group of conductive contacts is formed on the component side. A plurality of LEDs is mounted to the first group of conductive contacts and is arranged to define a first LED lighting circuit. The first group of conductive contacts and LEDs is arranged in an LED zone of the circuit board component side. A power driver is adapted to condition a supply electric power and output a conditioned electric power. The conditioned electric power is delivered to the first group of conductive contacts so as to power the first LED lighting circuit. A driver zone of the printed circuit board is defined on the component side of the circuit board and spaced from the LED zone. The power driver is mounted onto the driver zone.

In some such embodiment, the power driver case is a diffuse white color. In further embodiments a solder mask is disposed on the component side of the circuit board. The solder mask is white, and the power driver comprises a case that is also white.

In another embodiment, an elongate slot is formed through the printed circuit board, and the elongate slot is disposed between at least a portion of the LED zone and the driver zone. In some such embodiments the elongate slot is disposed between the power driver and a plurality of LEDs.

In another embodiment, the printed circuit board is a metal core circuit board.

In yet another embodiment, the printed circuit board has a non-conductive core.

In a yet further embodiment, a second group of conductive contacts is formed in the LED zone. A second plurality of LEDs is mounted to the second group of conductive contacts and is arranged to define a second LED lighting circuit that does not electrically communicate with the first LED lighting circuit.

Some embodiments additionally comprise a second power driver mounted in the driver zone of the printed circuit board. The second power driver is adapted to condition the supply electric power and output a conditioned electric power that is delivered to the second group of conductive contacts so as to power the second LED lighting circuit.

In still another embodiment, at least one conductive contact is formed in the driver zone, and no portion of the circuit board having a thermal conductivity greater than about 40 W/(m*K) connects the at least one conductive contact in the driver zone with any conductive contact in the LED zone.

In accordance with another embodiment, an LED-based light engine is provided, comprising a printed circuit board having an LED zone and a driver zone. A first group of conductive contacts is formed in the LED zone, and a plurality of LEDs are mounted to the first group of conductive contacts and arranged to define a first LED lighting circuit. A heat sink communicates with the driver zone. A power driver is adapted to condition a supply electric power and output a conditioned electric power. The conditioned electric power is delivered to the first group of conductive contacts so as to power the first LED lighting circuit. The power driver is mounted to the circuit board in the driver zone so that heat from the power driver flows to the circuit board at the driver zone and further to the heat sink. The driver comprises a plurality of electronic components enclosed within a power driver case. The driver case comprises a cup-shaped lower member and a lid that encloses a space between the lower member and the lid. The lower member has a bottom surface. The plurality of electronic components are disposed in the space and encased in a cured potting. The driver is mounted to the circuit board so that the driver lower member directly contacts the circuit board driver zone.

In one such embodiment, an air space is defined within the driver case between a surface of the potting and the lid. In another embodiment the driver case comprises a plurality of mount flanges extending outwardly from the driver case at or adjacent the driver case bottom surface, and fasteners engage the mount flanges to secure the driver case onto the circuit board.

In another embodiment, the lid is spaced from the circuit board.

In yet another embodiment, the driver case comprises a plurality of mount flanges extending outwardly from the driver case at or adjacent the driver case lid. Fasteners engage the mount flanges to secure the driver case onto the circuit board.

### BRIEF DESCRIPTION OF THE DRAWINGS

FIG. 1 shows a perspective view of an LED-based light engine embodiment having features in accordance with the present disclosure;

FIG. 2 shows the LED-based light engine of FIG. 1 incorporated into an LED-based luminaire;

FIG. 3 is an orthographic top view of the LED-based light engine of FIG. 1;

FIG. 4 is a side view of the LED-based light engine of FIG. 3;

FIG. 5 is a schematic view of the circuit disposed on one embodiment of the LED-based light engine of FIG. 3;

FIG. 6 shows a schematic view of an embodiment of a circuit board configured for use in an embodiment of the LED-based light engine of FIG. 1;

FIG. 7 is a cross-sectional view taken along lines 7-7 of FIG. 6;

FIG. 8 shows an embodiment of an assembled printed circuit board using the embodiment of FIG. 6;

FIG. 9 shows a top view of another embodiment of an LED-based light engine;

FIG. 10 shows a side view of the LED-based light engine of FIG. 9;

FIG. 11 shows a schematic view of the circuit of the LED-based light engine of FIG. 9;

FIG. 12 shows a top view of yet another embodiment of an LED-based light engine;

FIG. 13 shows a schematic view of the circuit board of the LED-based light engine of FIG. 12;

FIG. 14 shows a top view of still another embodiment of an LED-based light engine;

FIG. 15 shows a partial sectional view of a power driver and a portion of a circuit board of an LED-based light engine configured in accordance with one embodiment;

FIG. 16 shows a partial sectional view of another embodiment of a power driver;

FIG. 17 shows a top view of a still further embodiment of an LED-based light engine; and

FIG. 18 shows a side view of the LED-based light engine of FIG. 17.

### DESCRIPTION

The present specification and figures present and discuss non-limiting embodiments of an LED-based light engine and an associated LED-based luminaire. It is to be understood that the technologies and principles described herein can be applied to other luminaires of various shapes and sizes.

The illustrated embodiments employ prepackaged LEDs mounted in electric circuit(s) on printed circuit boards. There are various ways to configure such circuit boards, including depositing conductive metal layers on both sides of a non-conductive (such as FR4) circuit board body, and then etching the metal to create a desired pattern of electrical leads and contact pads to which components such as the prepackaged LEDs can be attached so as to form an electric circuit. Several embodiments and configurations of circuit boards for supporting LEDs are discussed in US Pub. No. US2010/0226139, entitled “LED-based Light Engine”, which is co-owned by the owner of the present application. The entirety of US2010/0226139 is hereby incorporated by reference into this application. Principles, configurations and construction methods as described in the incorporated publication can appropriately be used in conjunction with the inventive principles described herein.

With initial reference to FIG. 1, an embodiment of an LED-based light engine 30 is illustrated in which a printed circuit board 32 has a circuit formed on a component side 34 of the circuit board 32. Several prepackaged LEDs 36 are mounted on the circuit on the component side 34 of the printed circuit board 32. In the illustrated embodiment, first and second power drivers 40A, 40B are mounted on the printed circuit board 32, also on the component side 34 of the circuit board 32.

With additional reference to FIG. 2, in one embodiment the LED-based light engine 30 can be used in connection with a luminaire such as a ceiling-mounted light fixture 42. In the illustrated embodiment, the circuit board 32 is mounted to a base portion 44 of the light fixture 42, which base portion 44 can be mounted onto a ceiling. A light-dispersing cover 46 or diffuser is then attached to the based so as to enclose the LED-based light engine 30 within the light fixture. In a preferred embodiment, the light fixture base portion 44 is formed of a heat conductive material, such as metal, and helps to conduct heat generated during operation by the LEDs 36 and/or the power drivers 40A, 40B away from the circuit board 32 and to the environment.

With continued reference to FIGS. 1 and 2, and additional reference to FIGS. 3-5, additional views and components of the LED-based light engine 30 of FIGS. 1 and 2 are provided.

As shown schematically in FIG. 5, the LEDs 36 on the circuit board 32 are arranged in two separate circuits 50A, 50B. The first power driver 40A is configured to provide power across the first LED circuit 50A, and the second power driver 40B is configured to provide power across the second LED circuit 50B.

With specific reference to FIG. 3, an AC input power can be supplied to the power drivers 40A, 40B via input wires 52. The power drivers modify the input power by converting it to a DC output suitable for LEDs 36 at a desired voltage. The power drivers 40A, 40B provide the DC output to the LED circuits on the circuit board 32, thus lighting the LEDs 36 so that the light fixture supplies light. More specifically, and as shown in FIGS. 1 and 3, preferably first and second anode contact pads 54A, 54B and first and second cathode contact pads 56A, 56B are provided on the circuit board 32. As shown in FIG. 3, the DC output wires 60A of the first power driver 40A are electrically connected, such as by solder, to the first anode and cathode contact pads 54A, 56B, and the DC output wires 60B of the second power driver 40B are electrically connected, such as by solder, to the second anode and cathode contact pads 54B, 56B so as to provide power to the respective LED circuits.

In the illustrated embodiment, preferably the power drivers 40A, 40B comprise dimmable drivers. In the embodiment illustrated in FIG. 3, in which both drivers 40A, 40B are connected to the same AC input, the power drivers can be controlled by a single dimmer. In some embodiments the power drivers 40A, 40B can be supplied by independent AC inputs 52, and can be independently dimmable. In such embodiments, the first LED circuit 50A and the second LED circuit 50B can be dimmed separately, and thus can be run at different brightnesses. Additionally, in some embodiments the color configuration of the LEDs 36 in the first LED circuit 50A may be different than the color configuration of the LEDs 36 in the second LED circuit 50B. As such, dimming one of the LED circuits relative to the other LED circuit can change the overall color and/or color temperature emitted by the light engine 30.

Continuing with reference to FIG. 3, and with additional reference to FIG. 6, the illustrated printed circuit board 32 preferably has an LED circuit zone 70 and a driver zone 80. The LEDs 36 and associated componentry are mounted in the LED zone 70. The drivers 40A, 40B are mounted in the driver zone 80. In the illustrated embodiment, the driver zone 80 is defined generally centrally in a middle of the circuit board 32, and is surrounded by the LED zone 70. With reference also to FIG. 4, the power drivers 40A, 40B each comprise a casing 82 in which electronic driver components are enclosed. The case can be attached to the component side 34 of the circuit board 32 in the driver zone 80 via fasteners such as bolts 84 and nuts 86.

In the illustrated embodiment, a central aperture 88 is formed through the printed circuit board 32 in the driver zone 80, and the drivers 40A, 40B are mounted on opposing sides of the central aperture 88. The aperture may be helpful to increase convenience in some installations by providing access to an electric box in or on the ceiling or wall surface on which the associated light fixture is mounted. And as in the embodiment of FIG. 3, AC input power can extend through the aperture. Further, some embodiments of light fixtures employ central rods that can extend through the aperture to aid with installation. It is to be understood, however, that some embodiments may not include such a central aperture 88.

With particular reference to FIGS. 6 and 7, preferably the central or driver zone 80 of the printed circuit board 32 is thermally insulated relative to the LED zone of the circuit board 32. For example, in the illustrated embodiment, elongate slots 90 are disposed between at least part of the LED zone 70 and the driver zone 80. The slots 90 provide a physical interruption or barrier preventing heat generated by the LEDs 36 from passing along the circuit board 32 from the LED zone 70 to the driver zone 80, or heat generated by the driver from passing along the circuit board 32 from the driver zone 80 to the LEDs 36 in the LED zone 70. It is to be understood that various configurations, numbers, shapes and the like of slots 90 can be employed. For example, the illustrated slots 90 are straight. In other embodiments, the slot(s) can have an arcuate or other shape, and can be longer or shorter than the illustrated slots 90. Preferably, and as shown, multiple slots 90 are employed between the LED zone and the driver mount zone.

Features such as the slots 90 can be employed with various types of circuit boards. For example, in the illustrated embodiment the circuit board 32 is made of a nonconductive material such as FR4 that has been plated with copper. Circuits are then etched from the copper. As such, on the component side 34 of the printed circuit board 32 a plurality of contact plates 92 and leads are formed in the LED zone 70, providing for mounting of the LEDs 36 in a manner that both establishes the circuit powering the LEDs and provides a heat sink via relatively large contact plates 92 for the LEDs.

With continued reference to FIGS. 6 and 7, heat conductive plates 94 such as copper plates preferably are also formed in the driver zone 80. Such plates 94 also help conduct heat away from the drivers 40A, 40B mounted in the driver zone 80. However, preferably the copper plating on the component side 34 of the circuit board 32 in the driver zone 80 is insulated relative to and unconnected to contact plates 92 in the LED zone. As such, there is no heat conductive pathway connecting the LED zone 70 to the driver zone 80. To clarify, and since most materials, including FR4, will eventually conduct some heat, preferably there is no heat conductive pathway of any material having greater than a medium heat conductivity, such as greater than about 40 Watts per meter per Kelvin (W/(m*K)) formed on the circuit board 32 connecting contacts or leads of the LED zone 70 to contacts or leads of the driver zone 80.

In the embodiment illustrated in FIGS. 6 and 7, a back plate 96 of the board is provided on a back side 98 of the circuit board 32 opposite the component side 34, but is not etched. Thus, the back plate 96 covers the entire back side 98 of the circuit board 32. In the embodiment shown in FIG. 6, several small holes 99 can be formed through the circuit board 32 in the power driver mount zone. Heat conductive metal such as copper extends through these small apertures, creating thermal vias 100 that conduct heat from the driver zone plates 94 on the component side 34 to the back plate 96 on the back side 98. As such, a heat sink is created for the power drivers 40A, 40B, and a heat pathway is defined from the drivers 40A, 40B to the plates 94 on the component side 34, through the vias 100 and to the back plate 96. From the back plate 96 heat can be communicated to, for example, an associated light fixture or the environment. In the illustrated embodiment, thermal vias 100 are only provided in the driver zone 80.

In another embodiment, thermal vias 100 may be provided in the LED zone 70 but not the driver zone 80, so only heat from the LEDs 36 in the LED zone 70 is communicated to the back side 98 of the circuit board 32. In still another embodiment, thermal vias 100 may be provided in both the LED zone 70 and driver zone 80. However, contacts and plates 94 associated with the driver zone 80 are insulated from contacts and plates 92 associated with the LED zone 70, both on the component side 34 and the back side 98 of the circuit board 32. Further, in one such embodiment, a lighting fixture may be provided having two heat sinks. A first one of the heat sinks engages and draws heat from plates 92 associated with the LED zone 70. A second one of the heat sinks engages and draws heat from the plates 94 associated with the driver zone 80. Preferably the first and second heat sinks to not communicate heat readily between one another, so that the heat evacuation pathways of the LED zone 70 and driver zone 80 remain separated.

The illustrated embodiment comprises an FR4 board with typical etched copper plating. It is to be understood that other embodiments can employ other types of circuit boards such as, for example, a metal core circuit board. A metal core circuit board may be configured somewhat differently than the FR4-based circuit board due to its electrically- and thermally-conductive core. However, it can employ some of the same insulative principles. For example, a metal core circuit board may include one, two or several slots arranged between the LED zone and the power driver zone 80. The slots will create portions of reduced cross-sectional area in the board's metal core, creating heat flow bottlenecks that will help prevent or slow heat flow from the LED zone 70 to the driver zone 80, and vice versa.

With reference again to FIGS. 3-5, in a preferred embodiment a single circuit board design can be used with multiple configurations of LEDs. For example, in one embodiment the second power driver 40B has a different output voltage than the first power driver 40A. Also, certain portions of the second LED circuit 50B that are configured to receive LED packages will instead have, for example, zero value resistors mounted thereon. With particular reference to FIG. 5, it will be noted that several LEDs 105 are circled in the second LED circuit 50B. In one example embodiment, the circled LEDs 105 can be replaced with zero value resistors in order to accommodate a lower powered second power driver 40B. Preferably, and as indicated, the zero value resistors are placed so as to be dispersed around the LED zone so as to avoid creating hot or cold spots of light output.

FIG. 8 presents an embodiment of a circuit board 32 substantially similar to the one discussed above in connection with FIGS. 1-7. However, in this embodiment, the LEDs 36 are driven by one or more remote drivers that are not mounted on the circuit board 32, but which supply power to the LED circuits 50A, 50B via the illustrated DC output wires 60.

With reference next to FIGS. 9-11, another light engine embodiment is illustrated in which another circular circuit board 32 has an LED zone and a driver mount zone that are thermally insulated relative to one another. Slots are disposed between the LED zone 70 and driver zone 80, and the electrical contacts of the respective zones are not thermally connected to one another. In the illustrated embodiment, only one driver 40 is being employed to receive an AC input power and output a DC power to drive the LEDs 36 on the circuit board 32. As shown, the driver 40 preferably is mounted tightly to the circuit board 32 so as to put the driver case into a good thermal transfer relationship with the surface of the board. DC output wires 60 extend from the driver 40 to solder pads 54, 56 defined in the LED zone 70. As shown in FIG. 11, the LED circuit 50 is configured to be powered by a single power driver 40.

With reference next to FIGS. 12 and 13, another embodiment is illustrated of a LED-based light engine 130 having a circuit board 132 that is generally rectangular. Preferably, the driver 40 is mounted in a centrally defined driver mount zone that is surrounded by an LED zone. An LED circuit 50 is defined in the LED zone 70. Input AC power wires 52 extend through an aperture in the circuit board 132 and supply AC input power to the power driver 40, which modifies it into a suitable DC output power, which is communicated by output wires 60 to anode and cathode solder pads 54, 56 defined in the LED zone 70. Slots are disposed between the driver mount zone and at least some of the LEDs 36 in the LED zone 70. Further, as in embodiments discussed above, thermal vias 100 in the driver mount zone communicate heat from the driver 40 to a heat sink plate on the back of the printed circuit board 132.

FIG. 14 presents yet another embodiment of a light engine 230. The illustrated light engine 230 has a printed circuit board 132 having a rectangular shape. In the embodiment illustrated in FIG. 14, the driver mount zone is disposed at and adjacent a first end 110 of the printed circuit board 132, and the LED zone 70 takes up the rest of the circuit board. One or more power drivers 40 is mounted in the driver zone 80, and one or more LED circuits 50 is formed in the LED zone 70. The power driver 40 is configured to receive an AC input power, modify the input power, and output a DC output power via output wires 60 to, for example, an anode and cathode solder pad defined in the LED zone 70. In the illustrated embodiment the LED zone 70 makes up the majority of the surface area of the circuit board.

A plurality of elongate slots 90 are disposed between the driver zone 80 and the LED zone 70. The slots 90 define a line of separation between the LED zone 70 and the driver zone 80. It is to be understood that the circuits etched on these printed circuit boards can be configured to be scalable and modifiable. For example, in FIG. 14, the driver mount zone can be made large enough to accept two or more drivers 40, and the LED zone 70 can be configured with two or more independently-powered LED circuits. Preferably by configuring and adding components selectively to the etched contact plates 92 in the LED zone the illustrated luminaire can be configured to use two drivers to drive two independent LED circuits.

As with most printed circuit boards, preferably a solder mask is applied to the copper contact plates, and solder is applied to connection points, such as anode and cathode solder pads, on the plates where the solder mask is not applied. In some embodiments, there is no central solder mask in the driver mount zone, and the area immediately below where the driver case is mounted onto the printed circuit board.

In the illustrated embodiment, the solder mask is a diffuse white color that reflects light, thus maximizing light output of the luminaire. Preferably the cases of the drivers are similarly a diffuse white color that generally matches the solder mask color. As such, even though the driver cases are on the component side of the circuit board, and even though they are relatively bulky and extend outwardly from the circuit board, they do not have a visible effect on light output of the luminaire when included inside a light fixture. In another preferred embodiment, the drivers can be a diffuse color such as a diffuse silver color. In the illustrated embodiment the white drivers are substantially the same color as the white solder mask.

With reference next to FIG. 15, an embodiment of a driver case 200 has a generally cup-shaped lower portion 202 having a mount flange 204 near the top or rim of the cup. A lid 206 can close the cup-shaped lower portion 202. Preferably a printed circuit board carries a driver control circuit 208 that includes associated electronic componentry 210 for conditioning the AC input power and outputting an acceptable DC output power for powering an LED circuit.

Continuing with reference to FIG. 15, during manufacture the fully-assembled driver circuit board 208 is placed within the driver case lower portion 202, and a heat-conductive potting material (in its liquid phase) 212 is poured into the case, completely encapsulating the driver circuit board 208 and associated componentry. The lid 206 is applied to fully close the case 200. An adhesive can be used to seal the lid 206 in place. With similar processes, and in the illustrated embodiment, there often is an air gap 214 between the lid 206 and the potting material 212. Such air 214 can function as a thermal insulator. As such, in the illustrated embodiment, the driver case 200 is mounted so that a bottom surface 216 of the cup-shaped portion 202 is in contact with the printed circuit board driver zone 80, and the side of the driver 40 having the air space is positioned away from the circuit board 232. Thus, heat generated by the electronic componentry during operation of the driver 40 is communicated through the heat conductive potting and bottom case directly into the plates 94 on the component side 34 of the printed circuit board 232, further through the vias 100 and to the heat sink back plate 96.

With reference next to FIG. 16, another embodiment of a power driver case 200 is illustrated. In this embodiment, a cup-shaped lower portion 202 of the case 200 is closable by a lid 206 that engages the top rim of the cup 202. However, flanges 204A extend outwardly from the bottom surface 216 of the lower portion 202 rather than the top surface adjacent the lid 206. The flanges 204A preferably are configured to engage a fastener such as a bolt 220, but in a position immediately adjacent the circuit board.

With reference next to FIGS. 17 and 18, yet another embodiment is provided of an LED-based light engine 330. In the illustrated embodiment, an LED circuit having a plurality of LEDs 36 is arranged on a flat LED circuit board 370. A power driver 40 is mounted on a driver circuit board 380 that is formed separately from the LED circuit board 370. Preferably the driver circuit board 380 is arranged within a central aperture 384 formed through the LED circuit board 370. The driver 40 accepts an AC input power via input wires 52, and outputs a DC output power via DC output wires 60 that extend to and connect to anode and cathode solder pads 54, 56 formed on the LED circuit board 370 so as to provide power to the LED circuit.

In the illustrated embodiment the LED circuit board 370 and driver circuit board 380 are generally coplanar, but do not contact one another. Further, a thermally-insulative connector, such as the illustrated plastic ring 390, can hold the LED and driver circuit boards 370, 380 in place relative to one another. The illustrated plastic ring 390 preferably has an inner receiver slot 392 configured to receive and hold an outer perimeter edge 394 of the driver circuit board 380. An outer receiver slot 396 of the plastic ring 390 preferably is configured to receive and hold onto an inner aperture edge 398 of the LED circuit board 370. As such, the assembled LED-based light engine 330 can move as a single unit, but the LEDs 36 on the LED circuit board 370 are thermally isolated from the driver(s) 40 on the driver circuit board 380.

The embodiments discussed above have disclosed structures with substantial specificity. This has provided a good context for disclosing and discussing inventive subject matter. However, it is to be understood that other embodiments may employ different specific structural shapes and interactions.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above, but should be determined only by a fair reading of the claims that follow.

What is claimed is:

1. A light emitting diode (LED)-based light engine, comprising:
a printed circuit board having a component side and a back side, a first group of conductive contacts formed on the component side, a plurality of LEDs mounted to the first group of conductive contacts and arranged to define a first LED lighting circuit, the first group of conductive contacts and LEDs arranged in an LED zone of the circuit board component side;
a power driver adapted to condition a supply electric power and output a conditioned electric power, the conditioned electric power being delivered to the first group of conductive contacts so as to power the first LED lighting circuit;
a driver zone of the printed circuit board being defined on the component side of the circuit board and spaced from the LED zone, the power driver mounted onto the driver zone.

2. An LED-based light engine as in claim 1, wherein the power driver case is a diffuse white color.

3. An LED-based light engine as in claim 1, wherein a solder mask is disposed on the component side of the circuit board, the solder mask being white, the power driver comprising a case, the case being white.

4. An LED-based light engine as in claim 1, wherein an elongate slot is formed through the printed circuit board, and wherein the elongate slot is disposed between at least a portion of the LED zone and the driver zone.

5. An LED-based light engine as in claim 4, wherein the elongate slot is disposed between the power driver and a plurality of LEDs.

6. An LED-based light engine as in claim 4, wherein the printed circuit board is a metal core circuit board.

7. An LED-based light engine as in claim 4, wherein the printed circuit board has a non-conductive core.

8. An LED-based light engine as in claim 1, wherein a second group of conductive contacts is formed in the LED zone, a second plurality of LEDs mounted to the second group of conductive contacts and arranged to define a second LED lighting circuit that does not electrically communicate with the first LED lighting circuit.

9. An LED-based light engine as in claim 8 additionally comprising a second power driver mounted in the driver zone of the printed circuit board, the second power driver adapted to condition the supply electric power and output a conditioned electric power that is delivered to the second group of conductive contacts so as to power the second LED lighting circuit.

10. An LED-based light engine as in claim 1, wherein at least one conductive contact is formed in the driver zone, and no portion of the circuit board having a thermal conductivity greater than about 40 W/(m*K) connects the at least one conductive contact in the driver zone with any conductive contact in the LED zone.

11. An LED-based light engine, comprising:
a printed circuit board having an LED zone and a driver zone;
a first group of conductive contacts formed in the LED zone, a plurality of LEDs mounted to the first group of conductive contacts and arranged to define a first LED lighting circuit;
a heat sink communicating with the driver zone;
a power driver adapted to condition a supply electric power and output a conditioned electric power, the conditioned electric power being delivered to the first group of conductive contacts so as to power the first LED lighting circuit, the power driver being mounted to the circuit board in the driver zone so that heat from the power driver flows to the circuit board at the driver zone and further to the heat sink; and
the driver comprising a plurality of electronic components enclosed within a power driver case, the driver case comprising a cup-shaped lower member and a lid that encloses a space between the lower member and the lid, the lower member having a bottom surface, the plurality of electronic components being disposed in the space and encased in a cured potting;
wherein the driver is mounted to the circuit board so that the driver lower member directly contacts the circuit board driver zone.

12. An LED-based light engine as in claim 11, wherein an air space is defined within the driver case between a surface of the potting and the lid.

13. An LED-based light engine as in claim 12, wherein the driver case comprises a plurality of mount flanges extending outwardly from the driver case at or adjacent the driver case bottom surface, fasteners engaging the mount flanges to secure the driver case onto the circuit board.

14. An LED-based light engine as in claim 12, wherein the lid is spaced from the circuit board.

15. An LED-based light engine as in claim 14, wherein the driver case comprises a plurality of mount flanges extending outwardly from the driver case at or adjacent the driver case lid, fasteners engaging the mount flanges to secure the driver case onto the circuit board.
